(19) United States
(12) Patent Application Publication
(10) Pub. No.: US 2015/0364951 A1
(43) Pub. Date: Dec. 17, 2015

(54) SOLAR NUCLEAR FUSION DEVELOPMENT

(71) Applicant: CRAWFORD RENEWABLE ENERGY SOLUTIONS, LLC, Marietta, GA (US)

(72) Inventor: Kendal Marie Crawford, Marietta, GA (US)

(21) Appl. No.: 14/761,325

(22) PCT Filed: Jan. 16, 2014
(86) PCT No.: PCT/US14/11939

§ 371 Date: Jul. 16, 2015

Related U.S. Application Data
(60) Provisional application No. 61/753,235, filed on Jan. 16, 2013.
(60) Provisional application No. 61/784,129, filed on Mar. 14, 2013.

(51) Int. Cl. H02J 11/00; G21D 1/02; G21D 3/06; H02J 9/06; H02J 7/35

(52) U.S. Cl. CPC H02J 11/00; H02J 9/06; H02J 7/35; G21D 3/06; G21D 1/02

(57) ABSTRACT

Systems and methods for providing a solar photovoltaic (PV) facility as a source of secondary power for a nuclear power facility in the event of a power failure at the nuclear power facility. The solar PV facility is operably connected to the nuclear power facility by, e.g., a direct connection or through a substation. When a power failure at the nuclear power facility is detected, a switching system connects the solar PV facility to the nuclear power facility to provide a source of backup power to emergency systems. Power may be applied directly to such systems or to batteries at the nuclear power facility. In some implementations, the solar PV facility is physically located proximate to the nuclear power facility.

### CROSS REFERENCE TO RELATED APPLICATIONS

This application claims the benefit of priority to U.S. Provisional Application 61/753,235, filed Jan. 16, 2013, and U.S. Provisional Application 61/784,129, filed Mar. 14, 2013, which are both incorporated by reference herein in their entireties.

### BACKGROUND

Plant Vogtle Electric Generating Plant is currently in the process of constructing two additional nuclear reactors, Units #3 and #4, which are expected to achieve commercial operation in 2016 and 2017, respectively. These reactors are the first two nuclear licenses approved by the Nuclear Resource Commission (“NRC”) in 30 years, since the 1979 Three Mile Island nuclear accident in Pennsylvania. They are also the first nuclear reactors that will be constructed since the 2011 Fukushima tsunami disaster in Japan.

Because of Fukushima, the nuclear industry has worked diligently to make significant changes in the design structure and safety features of the reactors that are being built at Plant Vogtle. The two Westinghouse AP1000 reactors contain passive cooling systems with fewer pumps and valves, reducing operation and maintenance costs, in addition to enhanced safety systems aimed at mitigating emergency situations. The NRC approved a Combined Operating License (“COL”) for the two AP1000 reactors at Plant Vogtle in February, 2012. Vogtle Units #3 and #4 are the first licensed installations of the new AP1000 reactor design.

The NuStart Energy consortium is comprised of nuclear industry leaders involved in the standardization of the COL process of the AP1000 reactors at Plant Vogtle. Final designs of the Plant Vogtle project will be able to be used as reference in COL applications for new nuclear plants being proposed across the U.S. Design elements to be referenced include standardized licensing, engineering, technical, quality, and safety information. Currently, there are twenty eight new nuclear reactors proposed on eighteen U.S. nuclear plants awaiting COL approval by the NRC that could potentially implement the standardized design of the Westinghouse AP1000 nuclear reactors at Plant Vogtle. As such, it is imperative to develop state of the art safety systems since such systems can be standardized for use in future nuclear reactors and also applied to existing reactors. The current disclosure addresses these needs and concerns.

### SUMMARY

Disclosed herein is a system referred to as Solar-Nuclear Fusion Development (“SNF Development”). SNF Development involves the combination of utility-scale solar photovoltaic (“PV”) facilities physically proximate to and operably connected to a nuclear power plant. SNF Development offers an additional safety backup source of onsite and offsite power, which will provide substantial benefits for Plant Vogtle, as well as future nuclear reactors and existing reactors.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The foregoing summary, as well as the following detailed description of illustrative implementations, is better understood when read in conjunction with the appended Figures. For the purpose of illustrating the implementations, there are shown in the Figure example constructions; however, the implementations are not limited to the specific methods and instrumentalities disclosed.

FIG. 1 is a schematic diagram illustrating example connection between a solar photovoltaic facility and a nuclear power facility;

FIG. 2 is one line diagram for the solar PV facility;

FIG. 3 is a drawing of a switchyard design and connectivity of transmission lines within a nuclear power facility;

FIG. 4 is a one line diagram showing the location of the solar PV facility and point of interconnection as it relates to a main 230 KV transmission line. Substation details are also shown; and

FIG. 5 is a one line diagram of a point of interconnection referred to in FIG. 4.

FIG. 6 is a schematic of the SNF Development disclosed herein.

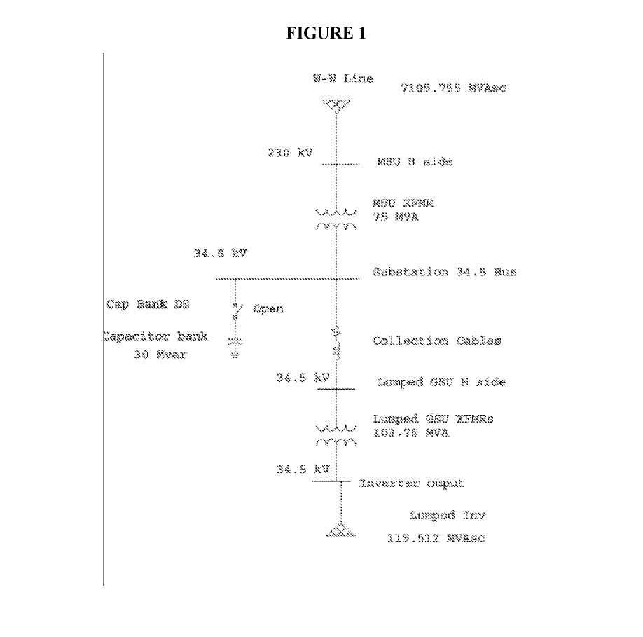

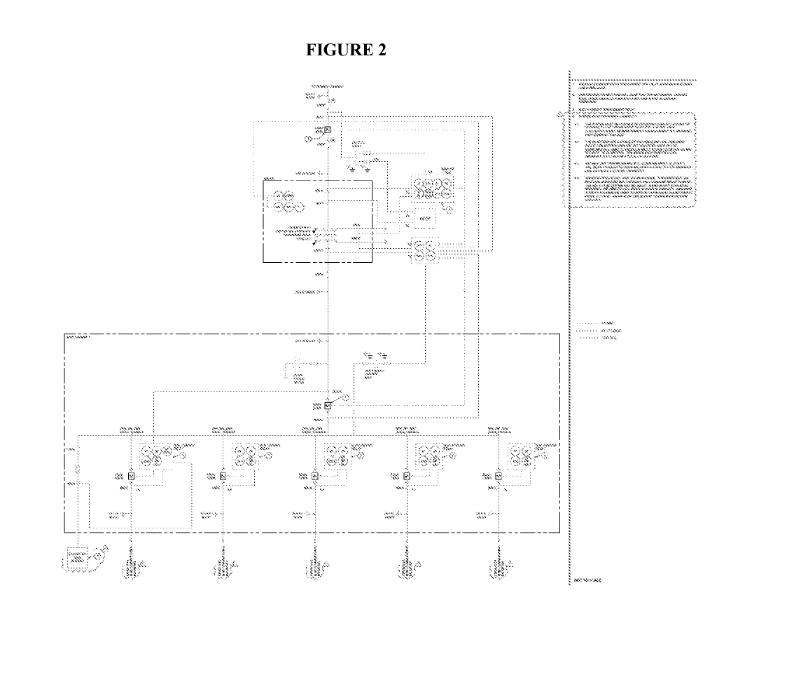

### DESCRIPTION

Before the present materials and methods are disclosed and described, it is to be understood that the aspects described below are not limited to specific manufacturing methods or designs, as such may, of course, vary. It is also to be understood that the terminology used herein is for the purpose of describing particular aspects only and is not intended to be limiting.

Disclosed herein is a system, the SNF Development, wherein at least a twenty Megawatt solar PV facility is operably connected to Plant Vogtle or some other nuclear facility. The disclosed solar PV facilities component of the SNF Development can be located on properties proximate to the nuclear facility. The disclosed SNF Development can be an independent project platform aimed at setting the design standards for application across a variety of reactor projects, including both (i) existing nuclear facilities currently in need of safety improvements; and (ii) newly proposed facilities, currently awaiting COL approvals by the NRC. By “operably connected” is meant that the solar PV facility can provide electrical power to the nuclear power facility sufficient for operating at least one critical process or device in the nuclear power facility, e.g., a cooling system. Operably connecting the solar PV facility to the nuclear power facility can be accomplished by a direct power connection between the two facilities.

For example, the solar PV facility and nuclear power facility may each be interconnected to an electrical grid that provides electricity to consumers of a power generating entity. Should the nuclear power facility experience a power failure, a switching system may enable the flow of power from the electrical grid to the nuclear power facility to provide power to the above mentioned at least one critical process or device. The switching mechanism may be an automatic relay that senses a loss of power at the nuclear power facility. In such implementations, a substation connected to the electrical grid may direct power from the solar PV facility and nuclear power facility using a bus associated with the switching mechanism. For example, upon detecting the loss of power, the switching mechanism may close the relay to make an electrical connection that enables the flow of power from the solar PV facility to nuclear power facility.

In other implementations, a dedicated connection may be provided between the solar PV facility and nuclear power facility. In such implementations, a switching mechanism (the same or different than above) may enable the flow of power from the solar PV facility over the dedicated connection to the nuclear power facility in the event of a power failure. In yet other implementations, a combination of the above connections may be used to provide redundant links between the solar PV facility and nuclear power facility.

Solar PV Facilities

In 2012, utility solar power installations reached an all-time high in the U.S. According to the U.S. Solar Market Insight Report, “Q2 2012 was the largest quarter ever for utility PV installations, as more than 20 projects were completed, totaling 447 MW's” (SEIA/GTM. (2012). U.S. Solar Market Insight Report, Q2 2012, Executive Summary. Solar Energy Industries Association, Greentech Media Company. Copyright 2012: SEIA/GTM Research, p 3). Forecasts predict solar PV installations are expected to continue to rise. Thus, the technology for the underlying solar PV facility has been applied.

As disclosed herein, a solar PV system is used to provide additional back up source of onsite and offsite power to a nuclear reactor in the event of emergency. Further, the solar PV facility can provide a reliable onsite AC power source that can be used for cooling the nuclear reactors in the event of an emergency. The solar PV facility can reduce plant stability risks occurring from loss of offsite power, in event of natural disaster (i.e., earthquake, hurricane, etc.) or severe weather, due to durability and ability to begin producing power again directly following the event, without relying on an outside fuel source (i.e., the next day that the sun rises, power production capabilities will recover, and can be used to feed power back into the grid). The solar PV facility can also extend the length of time and dependability of currently available backup power sources to fix problems in event of emergency.

Currently, nuclear reactors rely on a DC and/or AC power system for power backup. DC systems are in the form of underground station batteries. Existing emergency backup batteries typically only last four hours in most U.S. nuclear plants, including Plant Vogtle Units #1 and #2. The AP1000 reactors for Units #3 and #4 have six safety-related batteries, four of which last twenty-four hours and two of which last seventy-two hours; at that point the backup batteries would be expended and unable to provide additional power. With the disclosed SNF Development, solar PV facility can provide a continuous backup power source to recharge the batteries indefinitely in the event of an emergency. The solar PV facility can also provide backup power directly to the nuclear facility.

Fukushima had battery capacities of eight hours, which was not sufficient to prevent a nuclear meltdown. However, the Fukushima meltdown did not happen until ten days without power. The current emergency battery backup power source at most U.S. nuclear power plants is designed to last only four hours, which is half of the backup power that Fukushima had available at their facility. If there were solar power facilities located nearby, even if only a portion of the panels were still working, the chances of mitigating the problem and preventing the meltdown would have been substantially greater, due to the additional backup power source able to be used to power the batteries and cool the reactors.

AC back up power systems are in the form of diesel generators. The AP1000 and most additional emergency backup power systems at nuclear plants only comprise two generators with the ability to produce a total of four Megawatts of power running on diesel fuel, which requires additional fuel supply to be available and replenished onsite.

Solar power is a reliable, natural, daily replenished resource that is utilized in the disclosed SNF Development as a backup power source in order to prevent future scenarios of complications that may arise from reliance on the diesel generators alone. With the SNF Development, diesel systems can remain in place if already present in the nuclear facility or can be included in the SNF Development. The diesel systems can be saved for nighttime usage and/or to allow for additional backup power coverage in event of emergency.

The solar PV facility can also bridge potential gaps in deviations that could result in reduced load capacity of mechanical couplers (rebar concerns).

The solar PV facility can also be used to power cooling systems and offset containment heat loads from an inadvertent criticality. Inadvertent criticalities can occur during emergency or when the reactors need to be shut down for extended lengths of time. Reactors at Fukushima were continuing to generate heat and pressure well after they should have shut down, due to an inadvertent criticality from a nuclear chain reaction that continued after the control rods fell in (Gundersen, A. (2011). Fukushima and the Westinghouse-Toshiba AP1000. Burlington: Fairwinds Associates, Inc.). The AP1000 reactor containments are within 7/10 of a pound of pressure of its maximum design value. Any extra heat generated from an inadvertent criticality may push the containment pressure above what it is designed to handle.

Further the solar PV facility can provide additional power to run the emergency service water pumps required to cool the heat generated from the nuclear reactors, in order to prevent loss of ultimate heat sink. The solar PV facility could be used as a backup power source if there is an accident and the passive cooling system is unable to refill its water tank if the equipment onsite are severely damaged and access to the site is impaired. Such scenarios could exist from damage created during a hurricane, tornado, flood, earthquake, terrorist attack or a multiunit accident (i.e., explosion from one unit throws shrapnel into the air and either damages or clogs steam release in an adjacent unit).

The solar PV facility can provide power for Spent Fuel Pool cooling systems. The Spent Fuel Pool (“SFP”) cooling system in the AP1000 is similar to the design at Fukushima system, which created a hydrogen explosion during the emergency, resulting in the loss of the ultimate heat sink. The solar PV facility can be used as a backup to cool the SFP's in the event of a station blackout. The current backup power systems of the AP1000 reactors for SFP's is only designed to last seven days. The solar PV facility can provide continuous backup power for SFP's in the event of an emergency or extended refueling outage.

The solar PV facility can also reduce the potential power outage impact to local communities in the event of a station blackout. It can provide a backup power source during refueling procedures and prevent dangers associated with refueling power outages.

The solar PV facility contains inverters, which automatically pull from solar when needed. Thus, no personnel are needed onsite to activate protective measures in event of emergency. The solar PV facility can comprise from 120 to 130 inverters.

The solar PV facility can also allow additional time for maintenance if the plant needs to be shut down or come offline to fix technical or maintenance problems (i.e., leaking) Maintenance activities could therefore take place more frequently, which increases the overall safety of plant operation at nuclear power plants. As such, there is less risk associated with coming offline for maintenance requirements involving extended periods of time.

In the disclosed SNF Development, the solar PV facility produces at or at least 20 MW capability, for example, at or at least 50 MW capability, or at or at least 100 MW capability.

The solar PV facility is proximate to the nuclear power facility. By proximate is meant within 25 miles, more preferably within 5-15 miles, of the nuclear power facility. This distance reduces the risk of damage to the solar facility in the event of an emergency (i.e., explosion or meltdown). It also reduces risks to emergency crews and plant operators because the need for onsite personnel is mitigated by an offsite backup power source. This distance range allows the solar facility to be close enough to provide a source of offsite backup power and/or act as a Blackstart Unit for the nuclear power facility. In a preferred aspect, the solar PV facility is not directly adjacent to the nuclear power facility, and is not an “on site” power source. In other aspects, the solar PV facility is located “on site” of the nuclear power facility.

The solar PV facility site should also be located near a transmission line that ties into the nuclear power facility, such that power generated by both facilities is distributed onto the same transmission line, making it possible for power to be transmitted between the two facilities via Solar Nuclear Fusion Development. However, the solar PV facility must be interconnected separately and able to operate completely independently from the nuclear facility. For example, if there is a malfunction at the nuclear facility that triggers a number of chain reactions causing equipment to fail, there should be zero impact on the operating capabilities of the solar facility. The disclosed SNF Development requires that the solar PV facility is interconnected directly into a substation located on the transmission line.

The size of the transmission line can be 230 kV. While the disclosed SNF Development can be implemented on other sizes of transmission lines, 230 kV is ideal. The SNF Development can have a separate substation next to the solar PV facility on the shared transmission line with the nuclear power facility. This can provide more protection and control to the solar facility. The substation can separate the two facilities from potential impacts (e.g., chain reactions), regulating both facilities power loads and flows across the transmission line.

### Black Start

Along these lines, any time a nuclear power plant shuts down, regardless of if for maintenance or in the event of an emergency, intricate ramp down systems are activated to safely shut down the facility (i.e., emergency core cooling systems). These systems are designed to allow a gradual cooling process of the reactors, in order to prevent the loss of the ultimate heat sink and subsequent meltdown of the nuclear facility.

Due to the typically isolated location of most nuclear power facilities and high amount of power that is produced under normal operating conditions, as the plant shuts down it is possible that the transmission system will also fail due to the extensive loss of power being produced by the reactors, which would normally be distributed to consumers.

“Black Start” is the procedure to recover from this type of event, in which a total or partial shutdown of the transmission system has caused an extensive loss of power supplies. This entails isolated power stations being re-started individually, one by one, and gradually being reconnected to each other in order to restore an interconnected transmission system.

Under normal operation, electrical supply needed to start up power stations generally comes from the transmission or distribution system. However, under emergency conditions, if the power plant has Black Start capabilities, small onsite auxiliary generating facilities (i.e., diesel generators/battery systems) provide electrical supply to the Black Start station, in order to restore power to the plant and transmission system. Not all power stations have, or are required to have, this Black Start capability. There are also many rules and regulations for a generating facility to be considered a “Black Start Facility.” Black Start capability is usually a consideration when the plant is being built.

Typically a nuclear power facility owner will have mutual black start agreements with other utilities to (i) provide energy to the local consumers in the event of a shutdown; (ii) reboot (or “Black Start”) the transmission systems, if needed; and (iii) ensure availability of proper back up power required for operation of the security systems at the nuclear facility.

Thus, disclosed herein the SNF Development can be used as a Black Start facility for a nuclear power plant. Due to the intricate nature of the inherent design of the reactors, when a nuclear power plant has to be shut down during an emergency event, there is a probability that chain reactions may occur from the incident that can cause either (i) the onsite backup power supply systems (batteries/diesel generators) not to activate and become operational, or (ii) the onsite backup power supply systems (batteries/diesel generators) are destroyed as a direct result of the incident itself.

This can be problematic and potentially lead to a loss of the ultimate heat sink and subsequent nuclear meltdown for many reasons, especially when the transmission system fails, the onsite backup power supply systems fail to operate, and the nuclear power plant is too isolated to allow an additional power source to flow across transmission lines over a certain distance, much less provide power at a high enough voltage required for the Black Start of the nuclear facility.

Therefore, a more remote, offsite generator, such as a solar PV plant is disclosed herein as a second backup power source for a Black Start solution for nuclear power plants, i.e., a SNF Black Start Facility.

SNF Black Start Facilities should be constructed proximate to the nuclear power plant, as with the SNF Development. However, the distance between the nuclear facility and SNF Black Start Facility can extend further out (estimated 10-20 miles), as long as the solar PV facility is designed to produce sufficient capacity to Black Start the nuclear facility. The SNF Black Start Facility should be interconnected into to a separate substation along the same transmission lines that interconnect into the nuclear power plant.

The disclosed SNF Black Start Facility provides a secondary solution to Black Start the transmission system, maintains a “hot spot” in the transmission lines, and allows the flow of power to continue through the transmission lines, such that a larger supply from other utilities can be brought to the customers.

The distance between the other utility may be too great to allow flows to continue through the lines to the nuclear power customers, unless there is another power production facility maintaining power generation at an intermediary point in the transmission lines. A SNF Black Start Facility would maintain the power production and ensure the lines were “hot” enough to bring in outside power to customers while the nuclear power plant is shut down.

The disclosed SNF Black Start Facility can allow the flow of power to continue through the transmission lines, such that a larger supply from other utilities can be brought to the nuclear power plant, if needed during an extended emergency event, provide an additional backup power source for nuclear reactor ramp down process, safety shut down, and controlling systems, and provide an additional backup power source for starting the nuclear power facility's onsite backup power supply systems (diesel generators/battery systems).

The only concern regarding the ability of SNF Development to provide a continuous and reliable source of power sufficient to provide Black Start capabilities to a nuclear power plant, is the inherent nature of solar PV facilities, in which solar power is only produced during the daytime. Additionally, weather conditions and location of the nuclear power plant may impact the efficiency of the SNF Black Start Development plant on a daily basis. These concerns can be alleviated by the addition of a battery storage system at the solar PV facility, if necessary. In any case, the SNF Black Start Facility is designed to sufficiently meet the Black Start requirements of the proximate to nuclear power plant.

The solar PV facility can be built to meet the specific offset requirements needed to ensure compliance with NRC safety regulations.

The solar PV facility can offset potential delays in plant commercial operation, reduce anticipated increases in construction costs, reduce financial impacts to rate payers, and mitigate issues regarding potential increased power bills to consumers.

The solar PV facility can be incorporated in NuStart's standardization criteria for final design certification under the COL with NRC. NRC has granted approval of COL at Plant Vogtle, while allowing additional safety measures to be incorporated in the design criteria during construction after the licensing approval.

When implementing the BlackStart option of the disclosed SNF Development, the substation also serves as a control board that opens the lines and directs power flows across the transmission system from the solar facility to other power plants and to the nuclear power plant.

In order for a solar generator to act as an SNF Development Blackstart Unit, the interconnecting transmission line coming from the solar facility can tie into the nuclear plant's auxiliary power system at the point of interconnection on the other side of the line.

### Examples

The solar PV facility component of the disclosed SNF Development, in one example, is based on 125-SC800CP-US inverters. This inverter is limited to 880 kVA at 25° C. and 800 kVA at 50° C. At a net output of 100 MW, if each inverter is producing about 820 kW, the thermally limited reactive power is 216 MVAR. An analysis was run in ETAP (Electrical Transient Analyzer Program, available from ETAP/Operations Technology, Irvine, Calif.) using the power output and VAR output of the inverters as limited above.

### Plant Output Calculations No. 1

With 102.5 MW and negative 27 MVAR from the inverters, net plant output is 100.4 MW and 51 MVAR absorbed.

Load Flow Analysis
Loading Category (1): Absorb VAR
Generation Category (1): Absorb VAR
Load Diversity Factor: None

| | Swing | V-Control | Load | Total |
|---|---|---|---|---|
| Number of Buses: | 1 | 0 | 3 | 4 |

| | XFMR2 | XFMR3 | Reactor | Line/Cable | Impedance | Tie PD | Total |
|---|---|---|---|---|---|---|---|
| Number of Branches: | 2 | 0 | 0 | 1 | 0 | 0 | 3 |

Adjustments

| | Apply | Individual/ |
|---|---|---|
| | Adjustments | Global |
| Tolerance | | |
| Transformer Impedance: | Yes | Individual |
| Reactor Impedance: | Yes | Individual |
| Overload Heater Resistance: | No | |
| Transmission Line Length: | No | |
| Cable Length: | No | |
| Temperature Correction | | |
| Transmission Line Resistance: | Yes | Individual |
| Cable Resistance: | Yes | Individual |

Bus Input Data

| | | | | | Load | | | | | | | |
|---|---|---|---|---|---|---|---|---|---|---|---|---|
| | | | | | Constant | | | | | | | |
| Bus | | | Initial Voltage | | KVA | | Constant Z | | Constant I | | Generic | |
| ID | kV | Sub-sys | % Mag. | Ang. | MW | Mvar | MW | Mvar | MW | Mvar | MW | Mvar |
| Inverter ouput | 34.500 | 1 | 100.0 | 0.0 | | | | | | | | |
| Lumped GSU H side | 35.500 | 1 | 100.0 | 0.0 | | | | | | | | |
| MSU H side | 230.000 | 1 | 100.0 | 0.0 | | | | | | | | |
| Substation 34.5 Bus | 34.500 | 1 | 100.0 | 0.0 | | | | | | | | |
| Total Number of Buses: 4 | | | | | 0.000 | 0.000 | 0.000 | 0.000 | 0.000 | 0.000 | 0.000 | 0.000 |

| | | | |
|---|---|---|---|
| Generation Bus | Voltage | Generation | Mvar Limits |

| ID | kV | Type | Sub-sys | % Mag | Angle | MW | Mvar | % PF | Max | Min |
|---|---|---|---|---|---|---|---|---|---|---|
| Inverter ouput | 34.500 | Mvar/PF Control | 1 | 100.0 | 0.0 | 102.500 | −27.000 | −96.7 | | |
| MSU H side | 230.00 | Swing | 1 | 100.0 | 0.0 | | | | | |
| | | | | | | 102.500 | −27.000 | | | |

Line/Cable Input Data

Ohms or Siemens/1000 ft per Conductor (Cable) or per Phase (Line)

| | |
|---|---|
| Line/Cable | Length |

| ID | Library | Size | Adj. (ft) | % Tol. | #/Phase | T (° C.) | R | X | Y |
|---|---|---|---|---|---|---|---|---|---|
| Collection Cables | 35NALS1 | 1250 | 3000.0 | 0.0 | 5 | 75 | 0.018090 | 0.037490 | |

Line/Cable resistances are listed of the specified temperatures

2-Winding Transformer Input Data

| | | | | | | | | | | % Tap | | | | |
|---|---|---|---|---|---|---|---|---|---|---|---|---|---|---|
| Transformer | | Rating | | | | | Z Variation | | | Setting | | Adjusted | Phase Shift | |
| ID | Phase | MVA | Prim. kV | Sec. kV | % Z1 | X1/R1 | −5% | −5% | % Tol. | Prim. | Sec. | % Z | Type | Angle |
| Lumped GSU XFMRs | 3-Phase | 103.750 | 34.500 | 34.500 | 5.75 | 8.00 | 0 | 0 | 0 | 0 | 0 | 5.7500 | Dd | 0.000 |
| MSU XFMR | 3-Phase | 75.000 | 250.000 | 34.500 | 10.00 | 15.00 | 0 | 0 | 0 | 0 | 0 | 10.0000 | YNyn | 0.000 |

Branch Connections

| | | |
|---|---|---|
| | | % Impedance, Pos, Seq., |
| CKT/Branch | Connected Bus ID | 100 MVA Base |

| ID | Type | From Bus | To Bus | R | X | Z | Y |
|---|---|---|---|---|---|---|---|
| Lumped GSU XFMRs | 2W XFMR | Lumped GSU H side | Inverter ouput | 0.69 | 5.50 | 5.54 | |
| MSU XFMR | 2W XFMR | MSU H side | Substation 34.5 Bus | 0.89 | 13.30 | 13.33 | |
| Collection Cables | Cable | Substation 34.5 Bus | Lumped GSU H side | 0.09 | 0.19 | 0.21 | |

LOAD FLOW REPORT

| Bus | | Voltage | | Generation | | Load | | Load Flow | | | | | XFMR |
|---|---|---|---|---|---|---|---|---|---|---|---|---|---|
| ID | kV | % Mag. | Ang | MW | Mvar | MW | Mvar | ID | MW | Mvar | Amp | % PF | % Tap |
| Inverter ouput | 34.500 | 94.099 | 12.2 | 102.500 | −27.000 | 0 | 0 | Lumped GSU H side | 102.500 | −27.000 | 1885.1 | −96.7 | |
| Lumped GSU | 34.500 | 95.130 | 8.5 | 0 | 0 | 0 | 0 | Substation 34.5 Bus | 101.828 | −33.978 | 1885.1 | −94.8 | |
| H side | | | | | | | | Inverter ouput | −101.028 | 33.978 | 1885.1 | −94.8 | |
| MSU H side | 230.000 | 100.000 | 0.0 | −100.387 | 51.998 | 0 | 0 | Substation 34.5 Bus | −100.387 | 51.998 | 282.8 | −89.1 | |
| Substation | 34.500 | 95.100 | 8.3 | 0 | 0 | 0 | 0 | Lumped GSU H side | −101.512 | 34.218 | 1885.1 | −94.8 | |
| 34.5 Bus | | | | | | | | MSU H side | 101.512 | −34.218 | 1885.1 | −94.8 | |

[symbol]

Indicates a voltage regulated bus (voltage controlled or swing type machine connected to it) [symbol]
Indicates a bus with a load mismatch of more than 0.1 MVA

Bus Loading Summary Report

| | | | Directly Connected Load | | | | | | | | | | | |
|---|---|---|---|---|---|---|---|---|---|---|---|---|---|---|
| | | | Constant | | | | | | | | Total Bus Load | | | |
| Bus | | | kVA | | Constant Z | | Constant I | | Generic | | | | | Percent |
| ID | kV | Rated Amp | MW | Mvar | MW | Mvar | MW | Mvar | MW | Mvar | MVA | % PF | Amp | Loading |
| Inverter ouput | 34.500 | | 0 | 0 | 0 | 0 | 0 | 0 | 0 | 0 | 105.996 | 96.7 | 1885.1 | |
| Lumped GSU H side | 34.500 | | 0 | 0 | 0 | 0 | 0 | 0 | 0 | 0 | 107.157 | 94.8 | 1885.1 | |
| MSU H side | 230.000 | | 0 | 0 | 0 | 0 | 0 | 0 | 0 | 0 | 112.643 | 89.1 | 282.8 | |
| Substation 34.5 Bus | 34.500 | | 0 | 0 | 0 | 0 | 0 | 0 | 0 | 0 | 107.124 | 94.8 | 1885.1 | |

[symbol]

Indicates operating load of a bus exceeds the bus critical limit (100.0% of the Continuous Ampere rating). [symbol]
Indicates operating load of a bus exceeds the bus marginal limit (95.0% of the Continuous Ampere rating).

Branch Loading Summary Report

| | Cable & Reactor | | Transformer | | |
|---|---|---|---|---|---|
| CKT/Branch | Ampacity | Loading | Capability | Loading (input) | Loading (output) |

| ID | Type | (Amp) | Amp | % | (MVA) | MVA | % | MVA | % |
|---|---|---|---|---|---|---|---|---|---|
| [symbol] Lumped GSU XFMRs | Transformer | | | | 104.580 | 107.157 | 102.5 | 105.996 | 101.4 |
| MSU XFMR | Transformer | | | | 125.003 | 112.643 | 90.1 | 107.124 | 85.7 |

[symbol]

Indicates a branch with operating load exceeding the branch capability.

Branch Losses Summary Report

| | | | | | |
|---|---|---|---|---|---|
| | | | | | Vd |
| CKT/Branch | From-To Bus Flow | To-From Bus Flow | Losses | % Bus Voltage | % Drop |

| ID | MW | Mvar | MW | Mvar | kW | kvar | From | To | in Vmag |
|---|---|---|---|---|---|---|---|---|---|
| Lumped GSU XFMRs | 102.500 | −27.000 | −101.628 | 33.978 | 872.2 | 6977.9 | 94.1 | 95.1 | 1.03 |
| Collection Cables | 101.628 | −33.978 | −101.512 | 34.218 | 115.7 | 239.8 | 95.1 | 95.1 | 0.03 |
| MSU XFMR | −100.387 | 51.098 | 101.512 | −34.218 | 1125.4 | 16880.6 | 100.0 | 95.1 | 4.90 |
| | | | | | 2113.3 | 24098.2 | | | |

Alert Summary Report

% Alert Settings

| | Critical | Marginal |
|---|---|---|
| Loading | | |
| Bus | 100.0 | 95.0 |
| Cable | 100.0 | 95.0 |
| Reactor | 100.0 | 95.0 |
| Line | 100.0 | 95.0 |
| Transformer | 100.0 | 95.0 |
| Panel | 100.0 | 95.0 |
| Protective Device | 100.0 | 95.0 |
| Generator | 100.0 | 95.0 |
| Inverter/Charger | 100.0 | 95.0 |
| Bus Voltage | | |
| OverVoltage | 105.0 | 102.0 |
| UnderVoltage | 95.0 | 98.0 |
| Generator Excitation | | |
| OverExcited (Q Max.) | 100.0 | 95.0 |
| UnderExcited (Q Min.) | 100.0 | |

| | | | | | | | |
|---|---|---|---|---|---|---|---|
| Device ID | Type | Condition | Rating/Limit | Unit | Operating | % Operating | Phase Type |

Critical Report

| | | | | | | | |
|---|---|---|---|---|---|---|---|
| Inverter ouput | Bus | Under Voltage | 34.50 | kV | 32.46 | 94.1 | 3-Phase |
| Lumped GSU XFMRs | Transformer | Overload | 104.58 | MVA | 106.00 | 101.4 | 3-Phase |

Marginal Report

| | | | | | | | |
|---|---|---|---|---|---|---|---|
| Lumped GSU H side | Bus | Under Voltage | 34.50 | kV | 32.82 | 95.1 | 3-Phase |
| Substation 34.5 Bus | Bus | Under Voltage | 34.50 | kV | 32.81 | 95.1 | 3-Phase |

SUMMARY OF TOTAL GENERATION, LOADING & DEMAND

| | MW | Mvar | MVA | % PF |
|---|---|---|---|---|
| Source (Swing Buses): | −100.387 | 51.098 | 112.643 | 89.12 Leading |
| Source (Non-Swing Buses): | 102.500 | −27.000 | 105.996 | 96.70 Leading |
| Total Demand: | 2.113 | 24.098 | 24.191 | 8.74 Lagging |
| Total Motor Load: | 0.000 | 0.000 | 0.000 | |
| Total Static Load: | 0.000 | 0.000 | 0.000 | |
| Total Constant I Load: | 0.000 | 0.000 | 0.000 | |
| Total Generic Load: | 0.000 | 0.000 | 0.000 | |
| Apparent Losses: | 2.113 | 24.098 | | |
| System Mismatch: | 0.000 | 0.000 | | |

Number of Iterations: 4 [symbol]
indicates data missing or illegible when filed

### Plant Output Calculations No. 2

With 102.5 MW and negative 27 MVAR from the inverters, net plant output is 100.75 MW and 34.7 MVAR net produced.

Electrical Transient Analyzer Program
Load Flow Analysis
Loading Category (2): Produce VAR
Generation Category (2): Produce VAR
Load Diversity Factor: None

| | Swing | V-Control | Load | Total |
|---|---|---|---|---|
| Number of Buses: | 1 | 0 | 3 | 4 |

| | XFMR2 | XFMR3 | Reactor | Line/Cable | Impedance | Tie PD | Total |
|---|---|---|---|---|---|---|---|
| Number of Branches: | 2 | 0 | 0 | 1 | 0 | 0 | 3 |

Adjustments

| | Apply | Individual/ |
|---|---|---|
| | Adjustments | Global |
| Tolerance | | |
| Transformer Impedance: | Yes | Individual |
| Reactor Impedance: | Yes | Individual |
| Overload Heater Resistance: | No | |
| Transmission Line Length: | No | |
| Cable Length: | No | |
| Temperature Correction | | |
| Transmission Line Resistance: | Yes | Individual |
| Cable Resistance: | Yes | Individual |

Bus Input Data

| | | | | | Load | | | | | | | |
|---|---|---|---|---|---|---|---|---|---|---|---|---|
| | | | | | Constant | | | | | | | |
| Bus | | | Initial Voltage | | KVA | | Constant Z | | Constant I | | Generic | |
| ID | kV | Sub-sys | % Mag. | Ang. | MW | Mvar | MW | Mvar | MW | Mvar | MW | Mvar |
| Inverter ouput | 34.500 | 1 | 100.0 | 0.0 | | | | | | | | |
| Lumped GSU H side | 34.500 | 1 | 100.0 | 0.0 | | | | | | | | |
| MSU H side | 230.000 | 1 | 100.0 | 0.0 | | | | | | | | |
| Substation 34.5 Bus | 34.500 | 1 | 100.0 | 0.0 | | | 0.000 | −25.000 | | | | |
| Total Number of Buses: 4 | | | | | 0.000 | 0.000 | 0.000 | −25.000 | 0.000 | 0.000 | 0.000 | 0.000 |

| | | | |
|---|---|---|---|
| Generation Bus | Voltage | Generation | Mvar Limits |

| ID | kV | Type | Sub-sys | % Mag | Angle | MW | Mvar | % PF | Max | Min |
|---|---|---|---|---|---|---|---|---|---|---|
| Inverter ouput | 34.500 | Mvar PF Control | 1 | 100.0 | 0.0 | 102.500 | 27.000 | 96.7 | | |
| MSU H side | 230.000 | Swing | 1 | 100.0 | 0.0 | | | | | |
| | | | | | | 102.500 | 27.000 | | | |

Line/Cable Input Data

Ohms or Siemens/1000 ft per Conductor (Cable) or per Phase (Line)

| | |
|---|---|
| Line/Cable | Length |

| ID | Library | Size | Adj. (ft) | % Tol. | #/Phase | T (° C.) | R | X | Y |
|---|---|---|---|---|---|---|---|---|---|
| Collection Cables | 35NALS1 | 1250 | 3000.0 | 0.0 | 5 | 75 | 0.018090 | 0.037490 | |

Line/Cable resistance are listed at the specified temperatures.

2-Winding Transformer Input Data

| | | | | | | | | | | % Tap | | | | |
|---|---|---|---|---|---|---|---|---|---|---|---|---|---|---|
| Transformer | | Rating | | | | | Z Variation | | | Setting | | Adjusted | Phase Shift | |
| ID | Phase | MVA | Prim. kV | Sec. kV | % Z1 | X1/R1 | +5% | −5% | % Tol. | Prim. | Sec. | % Z | Type | Angle |
| Lumped GSU XFMRs | 3-Phase | 103.750 | 34.500 | 34.500 | 5.75 | 8.00 | 0 | 0 | 0 | 0 | 0 | 5.7500 | Dd | 0.000 |
| MSU XFMR | 3-Phase | 75.000 | 230.000 | 34.500 | 10.00 | 15.00 | 0 | 0 | 0 | 0 | 0 | 10.0000 | YNyn | 0.000 |

Branch Connections

| | | |
|---|---|---|
| | | % Impedance, Pos, Seq., |
| CKT/Branch | Connected Bus ID | 100 MVA Base |

| ID | Type | From Bus | To Bus | R | X | Z | Y |
|---|---|---|---|---|---|---|---|
| Lumped GSU XFMRs | 2W XFMR | Lumped GSU H side | Inverter ouput | 0.69 | 5.50 | 5.54 | |
| MSU XFMR | 2W XFMR | MSU H side | Substation 34.5 Bus | 0.89 | 13.30 | 13.33 | |
| Collection Cables | Cable | Substation 34.5 Bus | Lumped GSU H side | 0.09 | 0.19 | 0.21 | |

Equipment Cable Input Data

| Equipment | | | Ohms or Siemens/1000 ft per Conductor | | | | | | | | | O/L Heater | |
|---|---|---|---|---|---|---|---|---|---|---|---|---|---|
| Cable | Equipment | | | | Length | | | | | | | Resistance | |
| ID | ID | Type | Library | Size | Adj ( [symbol] ) | % Tol | #/plt | T (° C.) | R | X | Y | Adj. (ohm) | % Tol |
| Cable1 | Capacitor | Capacitor | 35MALS1 | 1250 | 10.0 | 6.0 | 2 | 75 | .02096 | .03700 | .0000857 | .0000 | 0.0 |
| | bank | | | | | | | | | | | | |

LOAD FLOW REPORT

| Bus | | Voltage | | Generation | | Load | | Load Flow | | | | | XFMR |
|---|---|---|---|---|---|---|---|---|---|---|---|---|---|
| ID | kV | % Mag. | Ang | MW | Mvar | MW | Mvar | ID | MW | Mvar | Amp | % PF | % Tap |
| Inverter ouput | 34.500 | 108.348 | 9.9 | 102.500 | 27.000 | 0 | 0 | Lumped GSU H | 102.500 | 27.000 | 1637.2 | 96.7 | |
| | | | | | | | | side | | | | | |
| Lumped GSU | 34.500 | 106.447 | 7.2 | 0 | 0 | 0 | 0 | Substation 34.5 Bus | 101.842 | 21.737 | 1637.2 | 97.8 | |
| H side | | | | | | | | Inverter ouput | −101.842 | −21.737 | 1637.2 | 97.8 | |
| MSU H side | 230.000 | 100.000 | 0.0 | −106.748 | −34.710 | 0 | 0 | Substation 34.5 Bus | −100.748 | −84.710 | 267.5 | 94.5 | |
| Substation | 34.560 | 106.321 | 7.1 | 0 | 0 | 0.000 | −28.280 | Lumped GSU H | −101.755 | −21.556 | 1637.2 | 97.8 | |
| 34.5 Bus | | | | | | | | side | | | | | |
| | | | | | | | | MSU H side | 101.755 | 49.816 | 1783.2 | 89.8 | |

* Indicates a voltage regulated bus (voltage controlled or swing type machine connected to if)
# Indicates a bus with a load mismatch of more than 0 1 MVA

Bus Loading Summary Report

| | | | Directly Connected Load | | | | | | | | | | | |
|---|---|---|---|---|---|---|---|---|---|---|---|---|---|---|
| | | | Constant | | | | | | | | Total Bus Load | | | |
| Bus | | | kVA | | Constant Z | | Constant I | | Generic | | | | | Percent |
| ID | kV | Rated Amp | MW | Mvar | MW | Mvar | MW | Mvar | MW | Mvar | MVA | % PF | Amp | Loading |
| Inverter ouput | 34.500 | | 0 | 0 | 0 | 0 | 0 | 0 | 0 | 0 | 105.996 | 96.7 | 1637.2 | |
| Lumped GSU H side | 34.500 | | 0 | 0 | 0 | 0 | 0 | 0 | 0 | 0 | 104.136 | 97.8 | 1637.2 | |
| MSU H side | 230.000 | | 0 | 0 | 0 | 0 | 0 | 0 | 0 | 0 | 106.559 | 94.5 | 267.5 | |
| Substation 34.5 Bus | 34.500 | | 0 | 0 | 0 | −28.260 | 0 | 0 | 0 | 0 | 113.295 | 89.8 | 1783.2 | |

* Indicates operating load of a bus exceeds the bus critical limit (100.0% of the Continuous Ampere rating).
# Indicates operating load of a bus exceeds the bus marginal limit (95.0% of the Continuous Ampere rating).

Branch Loading Summary Report

| | Cable & Reactor | | Transformer | | |
|---|---|---|---|---|---|
| CKT/Branch | Ampacity | Loading | Capability | Loading (input) | Loading (output) |

| ID | Type | (Amp) | Amp | % | (MVA) | MVA | % | MVA | % |
|---|---|---|---|---|---|---|---|---|---|
| Lumped GSU XFMRs | Transformer | | | | 104.580 | 105.995 | 101.4 | 104.136 | 99.6 |
| MSU XFMR | Transformer | | | | 125.003 | 113.295 | 90.6 | 106.559 | 85.2 |

* Indicates a branch with operating load exceeding the branch capability.

Branch Losses Summary Report

| | | | | | |
|---|---|---|---|---|---|
| | | | | | Vd |
| CKT/Branch | From-To Bus Flow | To-From Bus Flow | Losses | % Bus Voltage | % Drop |

| ID | MW | Mvar | MW | Mvar | kW | kvar | From | To | in Vmag |
|---|---|---|---|---|---|---|---|---|---|
| Lumped GSU XFMRs | 102.500 | 27.000 | −101.842 | −21.737 | 657.9 | 5263.2 | 108.3 | 106.4 | 1.90 |
| Collection Cables | 101.842 | 21.757 | −101.755 | −21.556 | 87.3 | 180.9 | 106.4 | 106.3 | 0.13 |
| MSU XFMR | −100.748 | 34.710 | 101.755 | 49.816 | 1007.1 | 15106.3 | 100.0 | 106.3 | 6.32 |
| | | | | | 1752.3 | 20550.4 | | | |

Equipment Cable and Overload Heater Losses Summary Report

| | | | % Voltage | | | |
|---|---|---|---|---|---|---|
| Connected Load | Cable/Overload Heater | Losses | | Terminal on | % Vd | % Vd |

| ID | Type | ID | Library | kW | kvar | Bus | Bus kV | Load kV | Operating | Starting |
|---|---|---|---|---|---|---|---|---|---|---|
| Capacitor bank | Capacitor | Cable1 | 35MALS1 | 0.1 | 0.1 | 106.32 | 106.32 | 106.32 | 0.00 | 0.00 |

Alert Summary Report

% Alert Settings

| | Critical | Marginal |
|---|---|---|
| Loading | | |
| Bus | 100.0 | 95.0 |
| Cable | 100.0 | 95.0 |
| Reactor | 100.0 | 95.0 |
| Line | 100.0 | 95.0 |
| Transformer | 100.0 | 95.0 |
| Panel | 100.0 | 95.0 |
| Protective Device | 100.0 | 95.0 |
| Generator | 100.0 | 95.0 |
| Inverter/Charger | 100.0 | 95.0 |
| Bus Voltage | | |
| Over Voltage | 105.0 | 102.0 |
| Under Voltage | 95.0 | 98.0 |
| Generator Excitation | | |
| OverExcited (Q Max.) | 100.0 | 95.0 |
| UnderExcited (Q Min.) | 100.0 | |

| | | | | | | | |
|---|---|---|---|---|---|---|---|
| Device ID | Type | Condition | Rating/Limit | Unit | Operating | % Operating | Phase Type |

Critical Report

| | | | | | | | |
|---|---|---|---|---|---|---|---|
| Inverter ouput | Bus | Over Voltage | 34.50 | kV | 37.38 | 108.3 | 3-Phase |
| Lumped GSU H side | Bus | Over Voltage | 34.50 | kV | 36.72 | 106.4 | 3-Phase |
| Substation 34.5 Bus | Bus | Over Voltage | 34.50 | kV | 36.68 | 106.3 | 3-Phase |

Marginal Report

| | | | | | | | |
|---|---|---|---|---|---|---|---|
| Lumped GSU XFMRs | Transformer | Overload | 104.58 | MVA | 104.14 | 99.6 | 3-Phase |

SUMMARY OF TOTAL GENERATION, LOADING & DEMAND

| | MW | Mvar | MVA | % PF |
|---|---|---|---|---|
| Source (Swing Buses): | −100.748 | −34.710 | 106.559 | 94.55 Lagging |
| Source (Non-Swing Buses): | 102.500 | 27.000 | 105.996 | 96.70 Lagging |
| Total Demand: | 1.752 | −7.710 | 7.907 | 22.16 Leading |
| Total Motor Load: | 0.000 | 0.000 | 0.000 | |
| Total Static Load: | 0.000 | −28.260 | 28.260 | 0.00 Leading |
| Total Constant I Load: | 0.000 | 0.000 | 0.000 | |
| Total Generic Load: | 0.000 | 0.000 | 0.000 | |
| Apparent Losses: | 1.752 | 20.550 | | |
| System Mismatch: | 0.000 | 0.000 | | |

Number of Iterations: 4 [symbol]
indicates data missing or illegible when filed

Based on a limited set of voltages and tap settings the SNF Development will meet the specified criteria.

### Plant Output Calculations No. 3

With 102.5 MW and negative 27 MVAR from the inverters, net plant output is 100.6 MW and 50.5 MVAR absorbed.

Load Flow Analysis
Loading Category (1): Absorb VAR
Generation Category (1): Absorb VAR
Load Diversity Factor: None

| | Swing | V-Control | Load | Total |
|---|---|---|---|---|
| Number of Buses: | 1 | 0 | 3 | 4 |

| | XFMR2 | XFMR3 | Reactor | Line/Cable | Impedance | Tie PD | Total |
|---|---|---|---|---|---|---|---|
| Number of Branches: | 2 | 0 | 0 | 1 | 0 | 0 | 3 |

Adjustments

| | Apply | Individual/ |
|---|---|---|
| | Adjustments | Global |
| Tolerance | | |
| Transformer Impedance: | Yes | Individual |
| Reactor Impedance: | Yes | Individual |
| Overload Heater Resistance: | No | |
| Transmission Line Length: | No | |
| Cable Length: | No | |
| Temperature Correction | | |
| Transmission Line Resistance: | Yes | Individual |
| Cable Resistance: | Yes | Individual |

Bus Input Data

| | | | | | Load | | | | | | | |
|---|---|---|---|---|---|---|---|---|---|---|---|---|
| | | | | | Constant | | | | | | | |
| Bus | | | Initial Voltage | | KVA | | Constant Z | | Constant I | | Generic | |
| ID | kV | Sub-sys | % Mag. | Ang. | MW | Mvar | MW | Mvar | MW | Mvar | MW | Mvar |
| Inverter ouput | 34.500 | 1 | 100.0 | 0.0 | | | | | | | | |
| Lumped GSU H side | 34.500 | 1 | 100.0 | 0.0 | | | | | | | | |
| MSU H side | 230.000 | 1 | 100.0 | 0.0 | | | | | | | | |
| Substation 34.5 Bus | 34.500 | 1 | 100.0 | 0.0 | | | | | | | | |
| Total Number of Buses: 4 | | | | | 0.000 | 0.000 | 0.000 | 0.000 | 0.000 | 0.000 | 0.000 | 0.000 |

| | | | |
|---|---|---|---|
| Generation Bus | Voltage | Generation | Mvar Limits |

| ID | kV | Type | Sub-sys | % Mag | Angle | MW | Mvar | % PF | Max | Min |
|---|---|---|---|---|---|---|---|---|---|---|
| Inverter ouput | 34.500 | Mvar/PF Control | 1 | 100.0 | 0.0 | 102.500 | −27.000 | −96.7 | | |
| MSU H side | 230.000 | Swing | 1 | 100.0 | 0.0 | | | | | |
| | | | | | | 102.500 | −27.000 | | | |

Line/Cable Input Data

Ohms or Siemens/1000 ft per Conductor (Cable) or per Phase (Line)

| | |
|---|---|
| Line/Cable | Length |

| ID | Library | Size | Adj. (ft) | % Tol. | #/Phase | T (° C.) | R | X | Y |
|---|---|---|---|---|---|---|---|---|---|
| Collection Cables | 35NALS1 | 1250 | 3000.0 | 0.0 | 5 | 75 | 0.018090 | 0.037490 | |

Line/Cable resistances are listed at the specified temperatures.

2-Winding Transformer Input Data

| | | | | | | | | | | % Tap | | | | |
|---|---|---|---|---|---|---|---|---|---|---|---|---|---|---|
| Transformer | | Rating | | | | | Z Variation | | | Setting | | Adjusted | Phase Shift | |
| ID | Phase | MVA | Prim. kV | Sec. kV | % Z1 | X1/R1 | −5% | −5% | % Tol. | Prim. | Sec. | % Z | Type | Angle |
| Lumped GSU XFMRs | 3-Phase | 103.750 | 34.500 | 34.500 | 5.30 | 6.89 | 0 | 0 | 0 | 0 | 0 | 5.3000 | Dd | 0.000 |
| MSU XFMR | 3-Phase | 75.000 | 230.000 | 34.500 | 10.00 | 20.00 | 0 | 0 | 0 | 0 | 0 | 10.0000 | YNyn | 0.000 |

Branch Connections

| | | |
|---|---|---|
| | | % Impedance, Pos, Seq., |
| CKT/Branch | Connected Bus ID | 100 MVA Base |

| ID | Type | From Bus | To Bus | R | X | Z | Y |
|---|---|---|---|---|---|---|---|
| Lumped GSU XFMRs | 2W XFMR | Lumped GSU H side | Inverter ouput | 0.73 | 5.06 | 5.11 | |
| MSU XFMR | 2W XFMR | MSU H side | Substation 34.5 Bus | 0.67 | 13.32 | 13.33 | |
| Collection Cables | Cable | Substation 34.5 Bus | Lumped GSU H side | 0.09 | 0.19 | 0.21 | |

LOAD FLOW REPORT

| Bus | | Voltage | | Generation | | Load | | Load Flow | | | | | XFMR |
|---|---|---|---|---|---|---|---|---|---|---|---|---|---|
| ID | kV | % Mag. | Ang | MW | Mvar | MW | Mvar | ID | MW | Mvar | Amp | % PF | % Top |
| Inverter ouput | 34.500 | 94.148 | 11.9 | 192.500 | −27.000 | 0 | 0 | Lumped GSU H side | 102.500 | −27.000 | 1884.1 | −96.7 | |
| Lumped GSU | 34.500 | 94.971 | 8.5 | 0 | 0 | 0 | 0 | Substation 34.5 Bus | 101.570 | −33.408 | 1884.1 | −95.0 | |
| H side | | | | | | | | | | | | | |
| | | | | | | | | Inverter ouput | −101.570 | 33.408 | 1884.1 | −95.0 | |
| MSU H side | 230.000 | 100.000 | 0.0 | −109.616 | −50.527 | 0 | 0 | Substation 34.5 Bus | −100.610 | 50.527 | 282.6 | −89.4 | |
| Substation 34.5 | 34.500 | 94.940 | 8.3 | 0 | 0 | 0 | 0 | Lumped GSU H side | −101.454 | 33.648 | 1884.1 | −94.9 | |
| Bus | | | | | | | | | | | | | |
| | | | | | | | | MSU H side | 101.454 | −33.648 | 1884.1 | −94.9 | |

[symbol]

Indicates a voltage regulated bus (voltage controlled or swing type machine connected to it) [symbol]
Indicates a bus with a load mismatch of more than 0.1 MVa

Bus Loading Summary Report

| | | | Directly Connected Load | | | | | | | | | | | |
|---|---|---|---|---|---|---|---|---|---|---|---|---|---|---|
| | | | Constant | | | | | | | | Total Bus Load | | | |
| Bus | | | kVA | | Constant Z | | Constant I | | Generic | | | | | Percent |
| ID | kV | Rated Amp | MW | Mvar | MW | Mvar | MW | Mvar | MW | Mvar | MVA | % PF | Amp | Loading |
| Inverter ouput | 34.500 | | 0 | 0 | 0 | 0 | 0 | 0 | 0 | 0 | 105.996 | 96.7 | 1884.1 | |
| Lumped GSU H side | 34.500 | | 0 | 0 | 0 | 0 | 0 | 0 | 0 | 0 | 106.923 | 95.9 | 1884.1 | |
| MSU H side | 230.000 | | 0 | 0 | 0 | 0 | 0 | 0 | 0 | 0 | 112.585 | 89.4 | 282.6 | |
| Substation 34.5 | 34.500 | | 0 | 0 | 0 | 0 | 0 | 0 | 0 | 0 | 106.889 | 94.9 | 1884.1 | |
| Bus | | | | | | | | | | | | | | |

[symbol]

Indicates operating load of a bus exceeds the bus critical limit (100.0% of the Continuous Ampere rating). [symbol]
Indicates operating load of a bus exceeds the bus marginal limit (95.0% of the Continuous Ampere rating).

Branch Loading Summary Report

| | Cable & Reactor | | Transformer | | |
|---|---|---|---|---|---|
| CKT/Branch | Ampacity | Loading | Capability | Loading (input) | Loading (output) |

| ID | Type | (Amp) | Amp | % | (MVA) | MVA | % | MVA | % |
|---|---|---|---|---|---|---|---|---|---|
| [symbol] Lumped GSU XFMRs | Transformer | | | | 104.580 | 106.923 | 102.2 | 105.996 | 101.4 |
| MSU XFMR | Transformer | | | | 125.003 | 112.585 | 90.1 | 106.889 | 85.5 |

[symbol]

Indicates a branch with operating load exceeding the branch capability

Branch Losses Summary Report

| | | | | | |
|---|---|---|---|---|---|
| | | | | | Vd |
| CKT/Branch | From-To Bus Flow | To-From Bus Flow | Losses | % Bus Voltage | % Drop |

| ID | MW | Mvar | MW | Mvar | kW | kvar | From | To | in Vmag |
|---|---|---|---|---|---|---|---|---|---|
| Lumped GSU XFMRs | 102.500 | −27.000 | −101.570 | 33.408 | 930.0 | 6408.0 | 94.1 | 95.0 | 0.82 |
| Collection Cables | 101.570 | −33.408 | −101.454 | 33.648 | 115.6 | 239.5 | 95.0 | 94.9 | 0.03 |
| MSU XFMR | −100.610 | 50.527 | 101.454 | −33.648 | 844.0 | 16879.5 | 100.0 | 94.9 | 5.06 |
| | | | | | 1889.6 | 23527.1 | | | |

Alert Summary Report

% Alert Settings

| | Critical | Marginal |
|---|---|---|
| Loading | | |
| Bus | 100.0 | 95.0 |
| Cable | 100.0 | 95.0 |
| Reactor | 100.0 | 95.0 |
| Line | 100.0 | 95.0 |
| Transformer | 100.0 | 95.0 |
| Panel | 100.0 | 95.0 |
| Protective Device | 100.0 | 95.0 |
| Generator | 100.0 | 95.0 |
| Inverter/Charger | 100.0 | 95.0 |
| Bus Voltage | | |
| OverVoltage | 105.0 | 102.0 |
| UnderVoltage | 95.0 | 98.0 |
| Generator Excitation | | |
| OverExcited (Q Max.) | 100.0 | 95.0 |
| UnderExcited (Q Min.) | 100.0 | |

Critical Report

| Device ID | Type | Condition | Rating/Limit | Unit | Operating | % Operating | Phase Type |
|---|---|---|---|---|---|---|---|
| Inverter ouput | Bus | Under Voltage | 34.50 | kV | 32.48 | 94.1 | 3-Phase |
| Lumped GSU H side | Bus | Under Voltage | 34.50 | kV | 32.76 | 95.0 | 3-Phase |
| Lumped GSU XFMRs | Transformer | Overload | 104.58 | MVA | 106.00 | 101.4 | 3-Phase |
| Substation 34.5 Bus | Bus | Under Voltage | 34.50 | kV | 32.75 | 94.9 | 3-Phase |

SUMMARY OF TOTAL GENERATION, LOADING & DEMAND

| | MW | Mvar | MVA | % PF |
|---|---|---|---|---|
| Source (Swing Buses): | −100.610 | 50.527 | 112.585 | 89.36 Leading |
| Source (Non-Swing Buses): | 102.500 | −27.000 | 105.996 | 96.70 Leading |
| Total Demand: | 1.890 | 23.527 | 23.603 | 8.01 Lagging |
| Total Motor Load: | 0.000 | 0.000 | 0.000 | |
| Total Static Load: | 0.000 | 0.000 | 0.000 | |
| Total Constant I Load: | 0.000 | 0.000 | 0.000 | |
| Total Generic Load: | 0.000 | 0.000 | 0.000 | |
| Apparent Losses: | 1.890 | 23.527 | | |
| System Mismatch: | 0.000 | 0.000 | | |

Number of Iterations: 4 [symbol]
indicates data missing or illegible when filed

### Plant Output Calculations No. 4

With 102.5 MW and negative 27 MVAR from the inverters, net plant output is 100.6 MW and 50.5 MVAR absorbed.

Load Flow Analysis
Loading Category (2): Produce VAR
Generation Category (2): Produce VAR
Load Diversity Factor: None

| | Swing | V-Control | Load | Total |
|---|---|---|---|---|
| Number of Buses: | 1 | 0 | 3 | 4 |

| | XFMR2 | XFMR3 | Reactor | Line/Cable | Impedance | Tie PD | Total |
|---|---|---|---|---|---|---|---|
| Number of Branches: | 2 | 0 | 0 | 1 | 0 | 0 | 3 |

Adjustments

| | Apply | Individual/ |
|---|---|---|
| | Adjustments | Global |
| Tolerance | | |
| Transformer Impedance: | Yes | Individual |
| Reactor Impedance: | Yes | Individual |
| Overload Heater Resistance: | No | |
| Transmission Line Length: | No | |
| Cable Length: | No | |
| Temperature Correction | | |
| Transmission Line Resistance: | Yes | Individual |
| Cable Resistance: | Yes | Individual |

Bus Input Data

| | | | | | Load | | | | | | | |
|---|---|---|---|---|---|---|---|---|---|---|---|---|
| | | | | | Constant | | | | | | | |
| Bus | | | Initial Voltage | | KVA | | Constant Z | | Constant I | | Generic | |
| ID | kV | Sub-sys | % Mag. | Ang. | MW | Mvar | MW | Mvar | MW | Mvar | MW | Mvar |
| Inverter ouput | 36.500 | 1 | 100.0 | 0.0 | | | | | | | | |
| Lumped GSU H side | 34.500 | 1 | 100.0 | 0.0 | | | | | | | | |
| MSU H side | 230.000 | 1 | 100.0 | 0.0 | | | | | | | | |
| Substation 34.5 Bus | 34.500 | 1 | 100.0 | 0.0 | | | 0.000 | −50.000 | | | | |
| Total Number of Buses: 4 | | | | | 0.000 | 0.000 | 0.000 | −50.000 | 0.000 | 0.000 | 0.000 | 0.000 |

| | | | |
|---|---|---|---|
| Generation Bus | Voltage | Generation | Mvar Limits |

| ID | kV | Type | Sub-sys | % Mag | Angle | MW | Mvar | % PF | Max | Min |
|---|---|---|---|---|---|---|---|---|---|---|
| Inverter ouput | 34.500 | Mvar/PF Control | 1 | 100.0 | 0.0 | 102.500 | 27.000 | 96.7 | | |
| MSU H side | 230.00 | Swing | 1 | 100.0 | 0.0 | | | | | |
| | | | | | | 102.500 | 27.000 | | | |

Line/Cable Input Data

Ohms or Siemens/1000 ft per Conductor (Cable) or per Phase (Line)

| | |
|---|---|
| Line/Cable | Length |

| ID | Library | Size | Adj. (ft) | % Tol. | #/Phase | T (° C.) | R | X | Y |
|---|---|---|---|---|---|---|---|---|---|
| Collection Cables | 35NALS1 | 1250 | 3000.0 | 0.0 | 5 | 75 | 0.015090 | 0.037490 | |

Line/Cable resistances are listed at the specified temperatures

2-Winding Transformer Input Data

| | | | | | | | | | | % Tap | | | | |
|---|---|---|---|---|---|---|---|---|---|---|---|---|---|---|
| Transformer | | Rating | | | | | Z Variation | | | Setting | | Adjusted | Phase Shift | |
| ID | Phase | MVA | Prim. kV | Sec. kV | % Z1 | X1/R1 | +5% | −5% | % Tol. | Prim. | Sec. | % Z | Type | Angle |
| Lumped GSU XFMRs | 3-Phase | 103.750 | 34.500 | 34.500 | 5.30 | 6.89 | 0 | 0 | 0 | 0 | 0 | 5.3000 | Dd | 0.000 |
| MSU XFMR | 3-Phase | 75.000 | 230.000 | 34.500 | 10.00 | 20.00 | 0 | 0 | 0 | 0 | 0 | 10.0000 | YNyn | 0.000 |

Branch Connections

| | | |
|---|---|---|
| | | % Impedance, Pos. Seq., |
| CKT/Branch | Connected Bus ID | 100 MVA Base |

| ID | Type | From Bus | To Bus | R | X | Z | Y |
|---|---|---|---|---|---|---|---|
| Lumped GSU XFMRs | 2W XFMR | Lumped GSU H side | Inverter ouput | 0.73 | 5.06 | 5.11 | |
| MSU XFMR | 2W XFMR | MSU H side | Substation 34.5 Bus | 0.67 | 13.32 | 13.33 | |
| Collection Cables | Cable | Substation 34.5 Bus | Lumped GSU H side | 0.09 | 0.19 | 0.21 | |

Equipment Cable Input Data

| Equipment | | | Ohms or Siemens/1000 ft per Conductor | | | | | | | | | O/L Heater | |
|---|---|---|---|---|---|---|---|---|---|---|---|---|---|
| Cable | Equipment | | | | Length | | | | | | | Resistance | |
| ID | ID | Type | Library | Size | Adj. (ft) | % Tol | #/ph | T (° C.) | R | X | Y | Adj. (ohm) | % Tol |
| Cable1 | Capacitor | Capacitor | 35NALS1 | 1250 | 10.0 | 0.0 | 2 | 75 | .02096 | .03700 | .0000357 | .0000 | 0.0 |
| | bank | | | | | | | | | | | | |

LOAD FLOW REPORT

| Bus | | Voltage | | Generation | | Load | | Load Flow | | | | | XFMR |
|---|---|---|---|---|---|---|---|---|---|---|---|---|---|
| ID | kV | % Mag. | Ang. | MW | Mvar | MW | Mvar | ID | MW | Mvar | Amp | % PF | % Tap |
| Inverter | 34.500 | 108.859 | 9.6 | 102.500 | 27.000 | 0 | 0 | Lumped GUS H side | 102.500 | 27.090 | 1629.5 | 96.7 | |
| ouput | | | | | | | | | | | | | |
| Lumped | 34.500 | 107.012 | 7.2 | 0 | 0 | 0 | 0 | Substation 34.5 Bus | 101.804 | 22.207 | 1629.5 | 97.7 | |
| GSU H | | | | | | | | Inverter ouput | −101.804 | −22.297 | 1629.5 | 97.7 | |
| side | | | | | | | | | | | | | |
| [symbol] MSU | 230.000 | 100.000 | 0.0 | −100.930 | −40.547 | 0 | 0 | Substation 34.5 Bus | −100.930 | −40.547 | 273.0 | 92.8 | |
| H side | | | | | | | | | | | | | |
| Substation | 34.500 | 106.886 | 71 | 0 | 0 | 0.000 | −34.274 | Lumped GSU H side | −101.718 | −22.028 | 1629.5 | 97.7 | |
| 34.5 Bus | | | | | | | | MSU H side | 101.718 | 56.302 | 1820.2 | 87.5 | |

[symbol]

Indicates a voltage regulated bus (voltage controlled or swing type machine connected to it) [symbol]
Indicates a bus with a load mismastch of more than 0.1 MVA

Bus Loading Summary Report

| | | | Directly Connected Load | | | | | | | | Total Bus Load | | | |
|---|---|---|---|---|---|---|---|---|---|---|---|---|---|---|
| Bus | | | Constant kVA | | Constant Z | | Constant 1 | | Generic | | | | | Percent |
| ID | kV | Rated Amp | MW | Mvar | MW | Mvar | MW | Mvar | MW | Mvar | MVA | % PF | Amp | Loading |
| Inverter ouput | 34.500 | | 0 | 0 | 0 | 0 | 0 | 0 | 0 | 0 | 105.996 | 96.7 | 1629.5 | |
| Lumped GSU H side | 34.500 | | 0 | 0 | 0 | 0 | 0 | 0 | 0 | 0 | 104.198 | 97.7 | 1629.5 | |
| MSU H side | 230.000 | | 0 | 0 | 0 | 0 | 0 | 0 | 0 | 0 | 108.770 | 92.8 | 273.0 | |
| Substation 34.5 Bus | 34.500 | | 0 | 0 | 0 | −34.274 | 0 | 0 | 0 | 0 | 116.360 | 87.5 | 1820.2 | |

[symbol]

Indicates operating load of a exceeds the bus critical limit (100.0% of the Continuous Ampere rating). [symbol]
Indicates operating load of a exceeds the bus marginal limit (95.0% of the Continuous Ampere rating).

Branch Loading Summary Report

| | Cable & Reactor | | Transformer | | |
|---|---|---|---|---|---|
| CKT/Branch | Ampacity | Loading | Capability | Loading (input) | Loading (output) |

| ID | Type | (Amp) | Amp | % | (MVA) | MVA | % | MVA | % |
|---|---|---|---|---|---|---|---|---|---|
| Lumped GSU XFMRs | Transformer | | | | 104.580 | 105.996 | 101.4 | 104.198 | 99.6 |
| MSU XFMR | Transformer | | | | 125.003 | 116.260 | 93.0 | 108.770 | 87.0 |

[symbol]

Indicates a branch with opersting load exceeding the branch capability.

Branch Losses Summary Report

| | | | | | |
|---|---|---|---|---|---|
| | | | | | Vd |
| CKT/Branch | From-To Bus Flow | To-From Bus Flow | Losses | % Bus Voltage | % Drop |

| ID | MW | Mvar | MW | Mvar | kW | kvar | From | To | in Vmag |
|---|---|---|---|---|---|---|---|---|---|
| Lumped GSU XFMRs | 102.500 | 27.000 | −101.804 | −22.207 | 695.7 | 4793.1 | 108.9 | 107.0 | 1.85 |
| Collection Cables | 101.804 | 22.207 | −101.718 | −22.028 | 86.5 | 179.2 | 107.0 | 106.9 | 0.13 |
| MSU XFMR | −100.930 | −40.547 | 101.718 | 56.302 | 787.7 | 15754.9 | 100.0 | 106.9 | 6.89 |
| | | | | | 1569.9 | 20727.2 | | | |

Equipment Cable and Overload Heater Losses Summary Report

| | | | % Voltage | | | |
|---|---|---|---|---|---|---|
| Connected Load | Cable/Overload Heater | Losses | | Terminal on | % Vd | % Vst |

| ID | Type | ID | Library | kW | kvar | Bus | Bus kV | Load kV | Operating | Starting |
|---|---|---|---|---|---|---|---|---|---|---|
| Capacitor bank | Capacitor | Cable1 | 35MALS1 | 0.1 | 0.2 | 106.89 | 106.89 | 106.89 | 0.00 | 0.00 |

Alert Summary Report

% Alert Settings

| | Critical | Marginal |
|---|---|---|
| Loading | | |
| Bus | 100.0 | 95.0 |
| Cable | 100.0 | 95.0 |
| Reactor | 100.0 | 95.0 |
| Line | 100.0 | 95.0 |
| Transformer | 100.0 | 95.0 |
| Panel | 100.0 | 95.0 |
| Protective Device | 100.0 | 95.0 |
| Generator | 100.0 | 95.0 |
| Inverter/Charger | 100.0 | 95.0 |
| Bus Voltage | | |
| OverVoltage | 105.0 | 102.0 |
| UnderVoltage | 95.0 | 98.0 |
| Generator Excitation | | |
| OverExcited (Q Max.) | 100.0 | 95.0 |
| UnderExcited (Q Min.) | 100.0 | |

| | | | | | | | |
|---|---|---|---|---|---|---|---|
| Device ID | Type | Condition | Rating/Limit | Unit | Operating | % Operating | Phase Type |

Critical Report

| | | | | | | | |
|---|---|---|---|---|---|---|---|
| Inverter ouput | Bus | Over Voltage | 34.50 | kV | 37.56 | 108.9 | 3-Phase |
| Lumped GSU H side | Bus | Over Voltage | 34.50 | kV | 36.92 | 107.9 | 3-Phase |
| Substation 34.5 Bus | Bus | Over Voltage | 34.50 | kV | 36.88 | 106.9 | 3-Phase |

Marginal Report

| | | | | | | | |
|---|---|---|---|---|---|---|---|
| Lumped GSU XFMRs | Transformer | Overload | 104.58 | MVA | 104.20 | 99.6 | 3-Phase |

SUMMARY OF TOTAL GENERATION, LOADING & DEMAND

| | MW | Mvar | MVA | % PF |
|---|---|---|---|---|
| Source (Swing Buses): | −100.930 | −40.547 | 108.770 | 92.79 Lagging |
| Source (Non-Swing Buses): | 102.500 | 27.000 | 105.996 | 96.70 Lagging |
| Total Demand: | 1.570 | −13.547 | 13.638 | 11.51 Leading |
| Total Motor Load: | 0.000 | 0.000 | 0.000 | |
| Total Static Load: | 0.000 | −34.274 | 34.274 | 0.00 Leading |
| Total Constant I Load: | 0.000 | 0.000 | 0.000 | |
| Total Generic Load: | 0.000 | 0.000 | 0.000 | |
| Apparent Losses: | 1.570 | 20.727 | | |
| System Mismatch: | 0.000 | 0.000 | | |

Number of Iterations: 4 [symbol]
indicates data missing or illegible when filed

### Example of Plant Vogtle

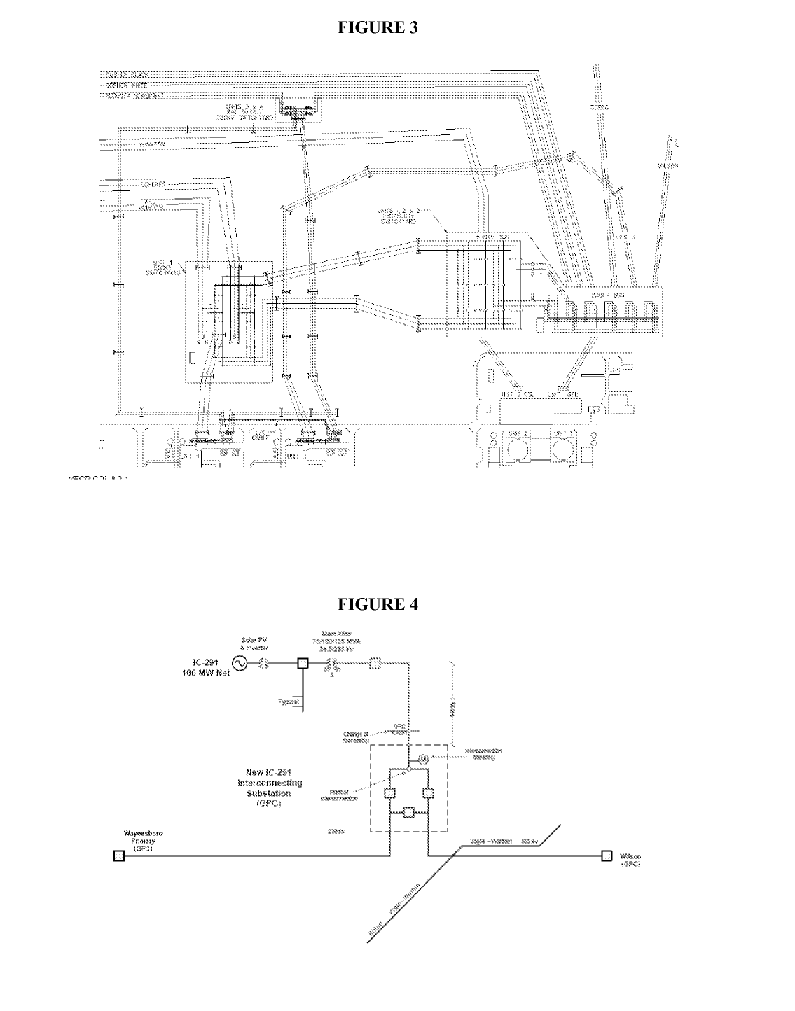

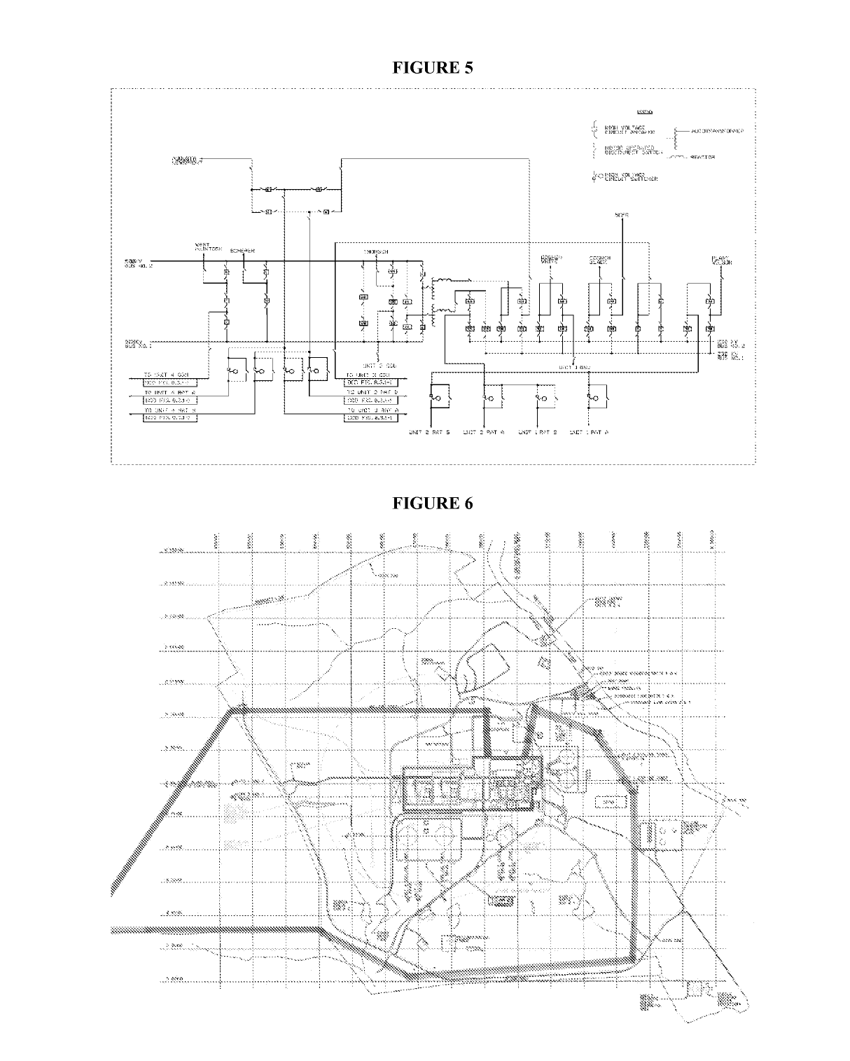

As an example of a SNF Development as disclosed herein, a solar PV facility can be place adjacent to Plant Vogtle. Multiple transmission circuits can be provided to support operation of Plant Vogtle, in addition to providing offsite power in case of an emergency. Units 3 and 4 can be supplied with off-site power from the transmission grid via two separate switchyard buses and backfed through the GSUs connected to the 230 and 500 kV lines (FIG. 3). The VEGP switchyards can be connected to eight transmission lines all of which are connected into each other such that if one failed, the likelihood of another to fail are substantial (i.e. chain reaction, not starting, etc.). This is Vogtle's only source of offsite power. Further, if more than one transmission line fails, there may not be any systems in place to restore these lines, and one by one they will likely continue to go down because they are so intertwined. Vogtle would now be isolated, islanding, and likely heading toward a station blackout. The SNF Development can combines every potential source of offsite power in the surrounding area and tie it in all together at the very place that is the most likely to have operational issues and need the backup offsite power the nuclear power facility itself.

What is claimed is:

1. A system, comprising: a solar photovoltaic (PV) facility operably connected to a nuclear power facility, wherein the solar PV facility provides power to the nuclear power facility in the event of a loss of power at the nuclear power facility.

2. The system of claim 1, wherein the solar PV facility is proximate to the nuclear facility.

3. The system of claim 1, wherein he solar PV facility is 5 to 15 miles from the nuclear power facility.

4. The system of claim 1, wherein the solar PV facility produces at or at least 20 MW of electricity.

5. The system of claim 1, wherein the solar PV facility produces at or at least 100 MW of electricity.

6. The system of claim 1, wherein the solar PV facility provides electrical power to a cooling system of the nuclear power facility.

7. The system of claim 6, wherein the cooling system is a spent fuel pool cooling system.

8. The system of claim 1, wherein the solar PV facility provides electrical power to an emergency service water pump of the nuclear power facility.

9. The system of claim 1, wherein the solar PV facility comprising from 120 to 130 inverters.

10. The system of claim 1, wherein the solar PV facility provides power for black start.

11. A method of providing a secondary source of power to a nuclear power facility, comprising:
operably connecting solar photovoltaic (PV) facility to the nuclear power facility;
detecting a loss of power at the nuclear power facility; and
upon detecting loss of power, providing power from the solar PV facility to the nuclear power facility.

12. The method of claim 10, further comprising determining that the loss of power is a complete loss of power at the nuclear power facility.

13. The method of claim 10, wherein the solar PV facility is proximate to the nuclear power facility.

14. The method of claim 10, further comprising applying the power from the solar PV facility to a cooling system of the nuclear power facility.

15. The method of claim 10, further comprising applying the power from the solar PV facility to emergency systems associated with nuclear power facility.

16. The method of claim 10, further comprising using the solar PV facility to provide power for black start.

17. The method of claim 10, wherein the solar PV facility is operably connected using a direct connection between the solar PV facility and the nuclear power facility.

18. The method of claim 10, wherein the solar PV facility is operably connected through a substation to the nuclear power facility.

19. The method of claim 10, further comprising applying the power from the solar PV facility to a battery backup system of the nuclear power facility.
